(19) United States
(12) Patent Application Publication
(10) Pub. No.: US 2014/0201707 A1
(43) Pub. Date: Jul. 17, 2014

(54) SYSTEMS AND METHODS FOR CREATING CUSTOMIZED APPLICATIONS

(71) Applicant: MERGE MOBILE, INC., San Clemente, CA (US)

(72) Inventor: Steve Schroeder, San Clemente, CA (US)

(73) Assignee: MERGE MOBILE, INC., San Clemente, CA (US)

(21) Appl. No.: 13/739,963

(22) Filed: Jan. 11, 2013

(51) Int. Cl. G06F 9/44

(52) U.S. Cl. CPC G06F 8/30; G06F 8/60
USPC 717/106

(57) ABSTRACT

Systems and methods for creating customized applications are provided. In particular, various embodiments of the present invention provide for systems and methods to create customized applications with user developed educational content (e.g., questions or games) around imported content. Once created, the customized applications can be distributed to end-users. Interactions with the customized application (e.g., responses to questions) can be tracked for both individual users and groups to allow for the generation of analytics. The analytics can be used measure and benchmark performance of the individual and group. For example, in the context of education, a customized application can be easily developed by a teacher around imported content such as that presented during a class lecture. The analytics can be used to track understanding of individuals and/or the group to gauge student understanding.

### TECHNICAL FIELD

Various embodiments of the present invention generally relate to systems and methods for building and distributing software applications. More specifically, various embodiments of the present invention relate to systems and methods for creating and distributing customized mobile applications.

### BACKGROUND

The proliferation of computing devices such as laptops, smart phones, tablets, and other mobile devices has generated a growing marketplace for mobile applications. Companies and businesses develop various mobile applications that enhance a user's experience with mobile devices. For example, mobile devices include applications that enable users to access email, take pictures, record video, play games, browse the web, and carry out e-commerce activities. However, developing applications for mobile devices still includes several challenges. For example, mobile devices cannot use software written for Microsoft, Lynx or Mac computer operating systems, mobile devices typically have limited hardware resources when compared to conventional computers, and mobile devices have small screens with each device having specific resolutions and dimensions that must be accounted for in the software code. In addition, mobile devices tend to have widely varying hardware and software configurations, including differences in computation power, memory size, display size, and the like. Mobile communication networks also experience limited network bandwidth and intermittent network availability.

The quality and functionality of mobile device applications has increased overtime. However, application development is still a difficult task and application development continues to lag dramatically behind the quantity and quality of software development for standard computers. Not only can the differences in programming languages be a barrier to entry for skilled engineers, these differences can be an even greater barrier for the novice. To further hinder application development, creating quality applications that run across multiple mobile device operating platforms is a difficult challenge. Thus, there exists a need for end-users of modern tablets, cell phones, and other mobile devices to be able to create customized applications that the end user can make available for mass and/or limited distribution in an efficient manner.

### SUMMARY

Systems and methods are described for providing applications with the ability for an end-user to create new content, customize pre-existing content, enhance pre-existing content, and package their works as a new application for mass and/or limited distributed to other mobile devices by the end-user. In some embodiments, a pre-existing piece of content is received through a content portal. The end-users developing the customized content package for the application may create their own content or download content as a document, recorded audio file, recorded video file, a picture or search content databases for content associated with one or more keywords provided by the end-user. The content may include a video file, an audio file, a document (e.g., PDF), executable software (e.g., JAVA code), or a picture (e.g., JPEG). The end user can enhance the content by adding a question (or set of questions), an answer (or set of answers), instructions, notes and opinions, and/or other content created or downloaded to complete the content package that will be contained in the distributed application.

In at least one embodiment, an end-user (e.g., teacher) selects educational material (e.g., guide on how to do linear algebra) as the content of interest. The end-user adds a set of instructions, opinions, questions, answers to the questions, and/or links to instructional websites to create the content package of the application. The end-user can then distribute the application to a mass audience or a targeted audience (e.g., students) to be used as reading material, a study guide, quiz, test or class exercise.

In another embodiment, a knowledge database may be searched for information regarding the end-users desired set of content. The key-words used for the search can be used to automatically present a proposed set of questions, educational text, reference list, links to related websites, links to related applications, links to interactive games, and other content from which an end-user can select. In other cases, the end-user may manually enter a proposed set of questions or other content. In addition, questions may be identified as an opinion question, repeat until correct questions are provided, allow for a set number of retry questions or as a question with a simple correct/incorrect answer. Still yet, a question can have rules describing the behavior of the question (e.g., allow retries, require a correct answer, etc.). In some embodiments, the question may be associated with multiple choice answers, text boxes, or other entry formats and response fields that allow for user inputs and responses.

A customized application is then created that shows the core content, instructions, educational content, the question(s), the text entry or multiple choice answers or response fields, and allows for user responses (e.g., text entry or selection of one of the multiple choice answers) and/or other interactions to be recorded. The customized application can then be distributed to a mass audience or a targeted set of users. The responses, response times, number of correct answers, time to complete all answers (and other data) are tracked and stored in a central database for each user, set of users, and all users. This information can be used in a variety of ways such as measuring and benchmarking performance of an individual, group, or all users. One or more operations may be available within the application as pre-configured features of the application. In one embodiment, performance statistics can be automatically calculated and displayed in various reports. In another embodiment, the end-user or user may draw over the core content or draw within the core content to enhance the core content.

One or more user interface screens may be displayed in the process for creating the customized application. In one embodiment, a first user interface screen is displayed on a terminal device (e.g., computer or mobile device). The first user interface screen can include a content selection screen configured to receive one or more elements of content from either a manual input or automatically selected based on keywords provided by the user. A second user interface screen may then be displayed on the terminal in response to receiving the one or more elements of content. The second user interface screen may be configured to allow for entry or selection of additional content (e.g., text, reading list, or one or more questions) regarding the one or more content element. Each end user created content elements/applications may be submitted to a marketplace that shows the one or more content elements/applications created by other end users. In some embodiments, the one or more content elements may be stored in a data structure that can be retrieved by an application. The user responses and interactions can be tracked and analytics may be generated based on the user responses and interactions. In some cases, this information can be used to create customized plans (e.g., lesson plans and marketing plans).

Embodiments of the present invention also include computer-readable storage media containing sets of instructions to cause one or more processors to perform the methods, variations of the methods, and other operations described herein.

In some embodiments, the applications created may include a progression through which the end-user is provided questions based upon meeting performance metrics (e.g., accuracy rate on questions, time restrictions). The end-user may set thresholds of performance for users prior to allowing access to other content elements, questions, additional end-user content, and additional content elements within the application.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Embodiments of the present invention will be described and explained through the use of the accompanying drawings in which:

FIG. 1 illustrates an example of a networked-based environment in which some embodiments of the present invention may be utilized;

FIG. 2 illustrates an example workflow for the creation, distribution, and use of a customized application in accordance with some embodiments of the present invention;

FIG. 3 shows a block diagram with components of a content marketplace in accordance with one or more embodiments of the present invention;

FIG. 4 shows a flow diagram illustrating interactions between applications and services in accordance with various embodiments of the present invention;

FIG. 5 is a block diagram of a customized application with examples of the content and services which may be included in accordance with one or more embodiments of the present invention;

FIG. 6 is a block diagram of a content creator application which may be used in accordance with some embodiments of the present invention;

FIG. 7 is a flowchart with a set of operations for generating analytics based on responses received through customized applications in accordance with some embodiments of the present invention;

FIG. 8 is a flowchart with a set of operations for measuring and benchmarking performance in accordance with various embodiments of the present invention;

FIGS. 9 and 10 are examples of performance reports which may be generated in accordance with one or more embodiments of the present invention;

FIG. 11 illustrates a data structure which some embodiments of the present invention may utilize;

FIGS. 12 and 13 illustrate examples of customized application that may be created in accordance with one or more embodiments of the present invention; and

FIG. 14 illustrates an example of a computer system with which some embodiments of the present invention may be utilized.

The drawings have not necessarily been drawn to scale. For example, the dimensions of some of the elements in the figures may be expanded or reduced to help improve the understanding of the embodiments of the present invention. Similarly, some components and/or operations may be separated into different blocks or combined into a single block for the purposes of discussion of some of the embodiments of the present invention. Moreover, while the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Systems and methods for creating customized applications are provided. In particular, various embodiments of the present invention provide for systems and methods to create customized applications with user developed questions or other supplemental content around imported or user created core content. In accordance with various embodiments, the customized applications can provide convenient interfaces for presenting dynamic content, content enhancement, and presentations. In addition, these customized applications can also provide convenient interfaces for evaluation, testing, and note taking. As such, embodiments of the system allow for a rapid deployment of content for individuals that want to publish workbooks, forms, study guides, test, structured learning flows (e.g., human resources) for distribution to a group of individual users (e.g., schools) or a mass market.

In some embodiments, a custom application creation tool can be used to absorb content (e.g., an image, a page, a video, an audio file, text, a pdf, etc.) regardless of the type of content or the content format. For example, a content creator can take a photo of class lecture notes, take a picture of an architectural diagram and ask a group of architecture students a set of meaningful questions about the diagram, or import a PDF document. This content ultimately becomes a page, or part of a page, in a project. For example, each photo, image, or page of a PDF can be treated as a page within the project.

As the pages within the project are created, they can be enhanced with questions and answers, instructions, tutorials, notes, drawings, hyperlinks, or other supplemental content. In addition, content creators can set up behaviors for the session (e.g., timed, requires all answers be correct, incremental performance required to progress, etc.). One advantage of this type of framework is that the supplemental content can easily and independently be created around the content page. In addition, the supplemental content can be independent of the content which allows content creators to conveniently associate any supplemental content they deem appropriate.

Once created, the customized applications can be distributed to users. Responses and interactions (e.g., to any questions, to each project, or to any part of the project) can be tracked for both individual users and groups to allow for the generation of analytics. The analytics can be used measure and benchmark performance of the individual and/or group. For example, in the context of education, a customized application can be easily developed by a teacher around imported content such as that presented during a class lecture. The analytics can be used to track understanding of individuals and/or the group to gauge student understanding. In addition to education, the applications created by the techniques disclosed herein may be applicable to marketing, polling, understanding opinions of a target audience, and many others.

While, for convenience, embodiments of the present invention are described with reference to distributed systems for creating customized applications, embodiments of the present invention are equally applicable to other computing models. In addition, the techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

### Terminology

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be coupled directly, or via one or more intermediary channels or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to various embodiments,” “in the embodiments shown,” “in other embodiments,” and the like generally mean the particular feature, structure, or characteristic following the phrase is included in at least one embodiment of the present invention, and may be included in more than one embodiment of the present invention. In addition, such phrases do not necessarily refer to the same embodiments or to different embodiments.

If the specification states a component or feature “may,” “can,” “could,” or “might” be included or have a characteristic, that particular component or feature is not required to be included or have the characteristic.

The term “module” refers broadly to software, hardware, or firmware (or any combination thereof) components. Modules are typically functional components that can generate useful data or other output using specified input(s). A module may or may not be self-contained. An application program (also called an “application”) may include one or more modules, or a module can include one or more application programs.

### GENERAL DESCRIPTION

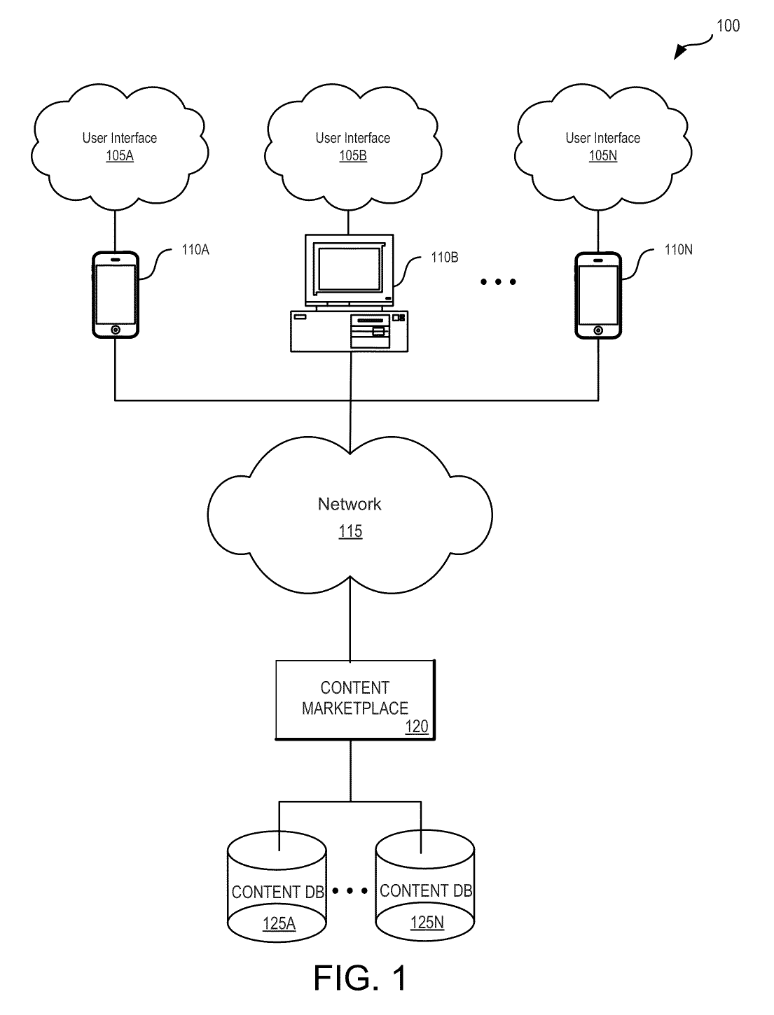

FIG. 1 illustrates an example of a networked-based environment 100 in which some embodiments of the present invention may be utilized. The embodiments illustrated in FIG. 1 show user interfaces 105A-105N running on computing devices 110A-110N, respectively. Computing devices 110A-110N can be any computing device capable of receiving user input as well as transmitting and/or receiving data via the network 115. In one embodiment, computing device 110A-110N may be a conventional computer system (e.g., a desktop or laptop computer) or a mobile device having computer functionality (e.g., a mobile telephone or a smart-phone). Computing devices 110A-110N may be configured to communicate with content marketplace 120 via the network 115. In some embodiments, computing devices 110A-110N can retrieve or submit information to content marketplace 120 and run one or more applications with customized content retrieved from content marketplace 120. For example, computing devices 110A-110N can execute a browser application or customized client to enable interaction between the computing devices 110A-110N and content marketplace 120.

Network 115 can include any combination of local area and/or wide area networks, using both wired and wireless communication systems. In one embodiment, network 115 uses standard communications technologies and/or protocols. Thus, network 115 may include links using technologies such as Ethernet, 802.11, worldwide interoperability for microwave access (WiMAX), 3G, 4G, CDMA, digital subscriber line (DSL), etc. Similarly, the networking protocols used on network 115 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over network 115 may be represented using technologies and/or formats including hypertext markup language (HTML) or extensible markup language (XML). In addition, all or some links can be encrypted using conventional encryption technologies such as secure sockets layer (SSL), transport layer security (TLS), and Internet Protocol security (IPsec).

Content marketplace 120 can be used to generate, distribute, and record interactions with a customized application based on information received through user interfaces 105A-105N. In some embodiments, content is received from an end-user through the user interfaces. The user developing the customized content for the application may select a template, edit a template, or create a new template (e.g., using an application editor). The customized content can then be submitted by the user, downloaded, or retrieved from content databases 125A-125N using search queries provided by the user. The content may include a video file, an audio file, a document (e.g., PDF), executable software (e.g., JAVA code), or a picture (e.g., JPEG).

Additional content can then be developed around the content element. For example, in some embodiments, the additional content may be educational content, marketing materials, interactive content, games, readings lists, links to websites related to the content element, one or more questions, one or more multiple-choice questions, reading material, text, or other content. The content element and additional content can then be presented in a customized application according to the template.

Once created, marketplace 120 can be configured to distribute the customized application to computing devices 110A-110N through internet 115. The computing devices 110A-110N can run the customized application and record responses from the end-users. These responses, or statistical summaries of the responses, may be recorded and then used generate a set of analytics based on the responses, interactions, or statistical summaries in order to measure and/or benchmark performance of an individual or group of individuals.

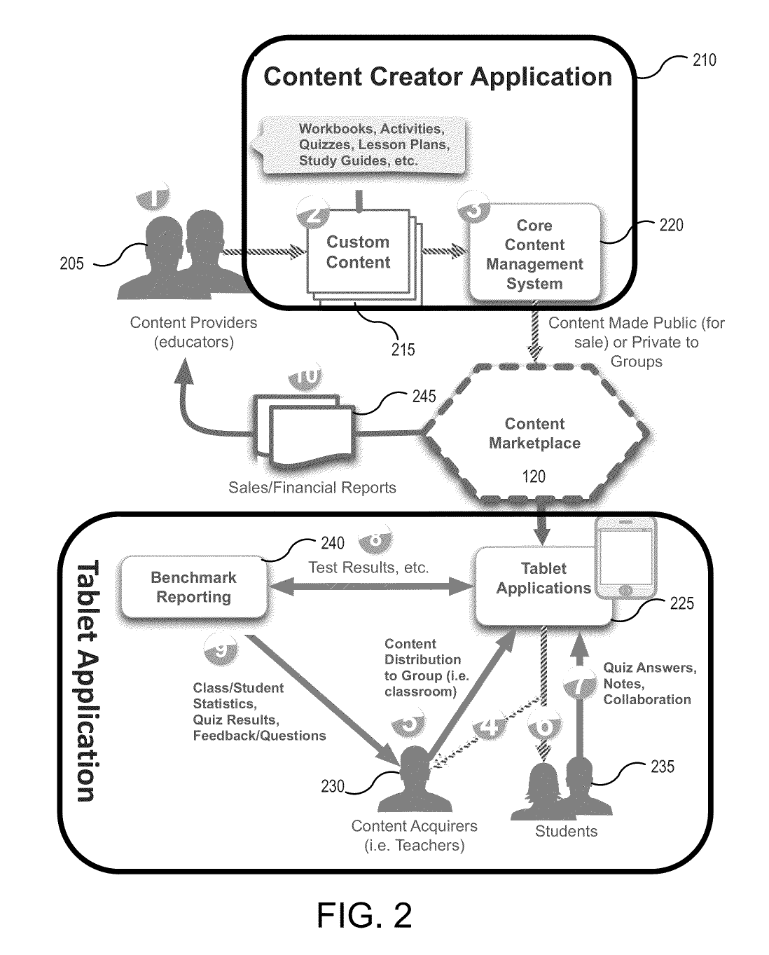

FIG. 2 illustrates an example workflow 200 for the creation, distribution, and use of a customized application in accordance with some embodiments of the present invention. As illustrated in FIG. 2, content providers 205 access content creator application 210 to create custom content 215. Content creator application 210 can be a standalone application running on a terminal device or run remotely on one or more servers accessed through a remote login.

Examples of custom content include, but are not limited to, workbooks, activities, quizzes, lesson plans, and study guides. In some embodiments, the custom content can be uploaded in PDF form or by using structured input forms within content management system 220. Once the raw content has been uploaded or entered into content management system 220, the content provider 205 may supplement the package with quiz questions, external URL links, photos, videos and text notes. These additional elements are indented to supplement the raw content provided to offer additional insight and resources regarding the subjects and topics covered. In some embodiments, the supplemental content can be assigned to a single page or globally to the content package.

Content assigned to a specific page will be available for viewing when the user navigates to that page. This can provide contextual insight. Once finalized, the content is submitted to content management system 220 where a final version of the content is stored and listed as a public (i.e., offered for sale) release or a restricted distribution to private groups. For example, content providers 205 can setup groups, such as classrooms, and assign content packages to those groups. Content marked for public sale may be subject to review based on submission guidelines. Approved content may then be made available in content marketplace 120 for public consumption. Declined content will be returned to content providers 205 for review and re-submission (if applicable).

In some embodiments, content providers 205 can add additional information and/or parameter regarding the content. For example, in the case of an educator, the content can be assigned a grade level (k-12, Higher Ed, etc.), subject (math, English, etc.), price, description, content type (workbooks, study guides, etc.), and/or keywords. This additional information can be valuable to content acquirers 230 (e.g., educators, students, and parents of students) in finding and evaluating whether to purchase the customized application.

Customized application 225 can be downloaded by content acquirers 230. In some cases, additional supplemental content can be added and distributed by one or more of content acquirers 230. Additional users 235 can also download and interact with customized application 225. For example, in some embodiments, educators can distribute content to a group by sending a private code to group members. Students can retrieve the private content via end user applications by entering the private code to receive all content for that group and/or individual id for a single content item. Once this content is downloaded to a local device, students may add custom notes, audio dictations, and comments to each page of the content package. Student annotations (notes, photos, etc.) will be stored in a sandboxed storage, allowing for multi-student support on a single device. In other embodiments, students can subscribe to group feeds to receive content.

The interactions of users 235 with customized application 225 can be monitored and recorded. Various analytics can be generated and used to create reports 240. For example, in an educational context, the report can provide class statistics, student statistics, quiz results, raw test results, usage statistics, and feedback or questions provided by the students. In some cases, this data may be aggregated and distributed. In addition to distributing the content, content marketplace can collect payments, generate various sales/financial reports 245, and distribute any payments that are due to content provider 205.

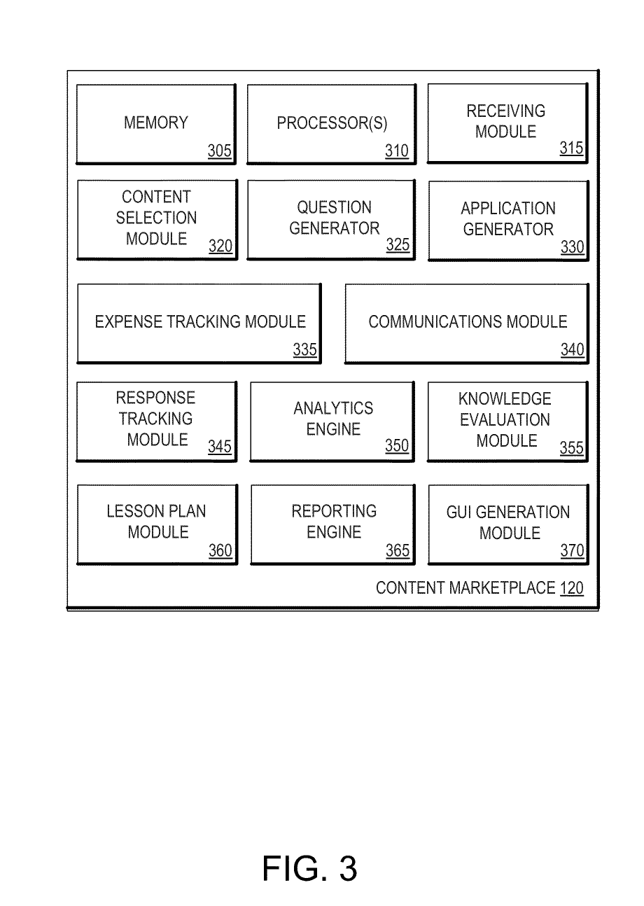

FIG. 3 shows a block diagram with components of content marketplace 120 in accordance with one or more embodiments of the present invention. According to the embodiments shown in FIG. 3, content marketplace 120 can include memory 305, one or more processors 310, receiving module 315, content selection module 320, question generator 325, application generator 330, expense tracking module 335, communications module 340, response tracking module 345, analytics engine 350, knowledge evaluation module 355, lesson plan module 360, reporting engine 365, and graphical user interface (GUI) generation module 370. Other embodiments of the present invention may include some, all, or none of these modules and components along with other modules, applications, and/or components. Still yet, some embodiments may incorporate two or more of these modules and components into a single module and/or associate a portion of the functionality of one or more of these modules with a different module. For example, in one embodiment, receiving module 315 and content selection module 320 can be combined into a single module for receiving and selecting content elements.

Memory 305 can be any device, mechanism, or populated data structure used for storing information. In accordance with some embodiments of the present invention, memory 305 can encompass any type of, but is not limited to, volatile memory, nonvolatile memory and dynamic memory. For example, memory 305 can be random access memory, memory storage devices, optical memory devices, media magnetic media, floppy disks, magnetic tapes, hard drives, SDRAM, RDRAM, DDR RAM, erasable programmable read-only memories (EPROMs), electrically erasable programmable read-only memories (EEPROMs), compact disks, DVDs, and/or the like. In accordance with some embodiments, memory 305 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as memory 305

Memory 305 may be used to store instructions for running one or more applications or modules on processor(s) 310. For example, memory 305 could be used in one or more embodiments to house all or some of the instructions needed to execute the functionality of receiving module 315, content selection module 320, question generator 325, application generator 330, expense tracking module 335, communications module 340, response tracking module 345, analytics engine 350, knowledge evaluation module 355, lesson plan module 360, reporting engine 365, and/or graphical user interface (GUI) generation module 370.

Receiving module 315 can be configured to receive content elements that will be used to create the customized applications. The content elements may originate from a computing device the developer is using to create pages of a content package within the custom application. In other embodiments, the content element may be retrieved by searching one or more databases using content selection module 320. For example, content selection module 320 may use one or more graphical user interface screens to receive search queries from developers. The queries can be used to search the databases. The results from the search queries are returned and then presented to the developer allowing for a selection of one or more of the results.

Question generator 325 can be used to assist the developer in creating questions around the content element. In some cases, the developer may submit keywords about the content element. These keywords can be used to determine questions about the content element from which the developer can select and/or edit. In other cases, question generator 325 may receive manually entered questions directly from the developer. For example, suppose a class is reading a book and the teacher wants to test if the students have read the book. The teacher can search for questions about the book which have already been generated. The teacher can then select which questions, if any, to be included within the content package.

Application generator 330 generates applications based on the content element, additional content, and questions submitted and/or selected by the developer. In some embodiments, application generator 330 generates the custom application based on one or more organizational or layout templates, supporting computing platforms (e.g., Android), screen size, or other factor. The application(s) may be generated immediately upon receipt of the content element and question. In other cases, the applications may be generated upon request from consumers. The request from the consumers may indicate specifics about the computing device which will nm the customized application. As such, application generator 330 may generate the requested application at that time.

Expense tracking module 335 tracks and bills any expenses or charges which may be assessed to the developers and/or the end-users. While in some embodiments, distribution of the customized applications to the end-users may be free, in other embodiments a charged may be assessed to the end-user, the developer, and/or other third-party. Still yet, charges may be assessed for running analytics, generating reports, or providing other services using content marketplace 120. In some cases, the fee structure could be a flat fee for service (e.g., periodically or per job). In other cases, each feature within the system may include one or more prices (e.g., based on subscription levels).

Communications module 340 may be configured to manage and translate any requests or messages from user interfaces 105A-105N, graphical user interface screens, content marketplace 120, and/or any other component into a format required by the destination component and/or system. Similarly, communications module 340 may be used to communicate between systems and/or modules that use different communication protocols, data formats, or messaging routines. According to some embodiments, system components can communicate through messaging methods including extensible markup language (XML), proprietary message formats, and/or others.

Response tracking module 345 may be configured to track the responses and interactions with the customized applications (e.g., time spent interacting with the customized application or answers to the question(s) within the customized applications) from the group of end-users. These responses and interactions may be submitted to analytics engine 350 which can generate a set of analytics for each end-user, subsets of the group of end-users, and/or the group of end-users. These analytics can be used to measure and benchmark performance of the end-users regarding the content element. For example, in the field of education, knowledge evaluation module 355 may be configured to evaluate the responses generated by each end-user and to identify deficiencies in a knowledge base of each end-user around the content element. This assessment may be passed to lesson plan module 360 a lesson plan based on the deficiencies and strengths may be generated for a teacher.

Reporting engine 365 may be configured to generate a report regarding each end-user and the group of end-users based on the responses and interactions (e.g., responses to the questions) received through the customized application. In some cases, these reports may be presented through a GUI screen generated by GUI generation module 350. GUI generation module 370 can generate one or more other GUI screens that allow for interaction with a user of a computing device. In at least one embodiment, GUI generation module 370 generates a graphical user interface allowing a user to set preferences, present reports, receive lesson plans, prioritize applications, prioritize application functionality, and/or otherwise receive or convey information to the user.

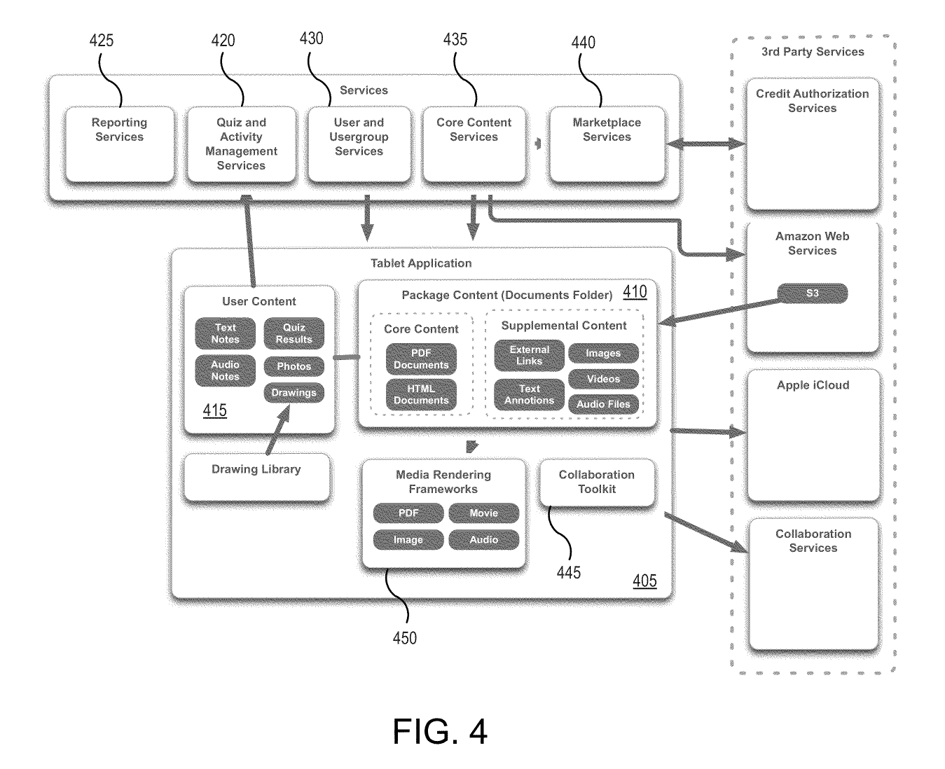

FIG. 4 shows a flow diagram illustrating interactions between applications and services in accordance with various embodiments of the present invention. As illustrated, custom application 405 can include package content 410 (e.g., core content and supplemental content) created by a content creator and downloaded or purchased from a marketplace (e.g., Amazon Web Services). Once the package content is downloaded, custom application 405 allows additional user content 415 to be created or uploaded by a user. Examples include text notes, audio notes, quiz results, photos, and drawings. In some embodiments, the quiz results can be reported to a quiz activity management service 420. Performance data and quiz result can be maintained locally until a successful transfer can be verified with quiz activity management service 420.

In addition, custom application may access other services such as reporting services 425, user and user group services 430, core content services 435, and/or marketplace services 440. Reporting services 425 analyze the quiz result received by quiz and activity management service 420 and generate one or more reporting with usage and benchmark data. User and user group services 430 can collect and distribute notes from multiple users of custom application 405. Any updates to the content can be propagated to custom application 405 through the core content services 435. Core content services 435 can also transmit these changes to various third-party marketplaces (e.g., Amazon Web Services). Marketplace services 440 can interface with various credit authorization services and other payment mechanisms.

In some embodiments, custom application 405 can include a collaboration toolkit 445 which can interact with third-party collaboration services. In addition, the user content can be backup using third-party services (e.g., Apple iCloud). Custom application 405 may also include various media rendering frameworks 450 which allow the dynamic content to be rendered as images, movies, pdf's, and/or audio files which can be viewed outside of the custom application.

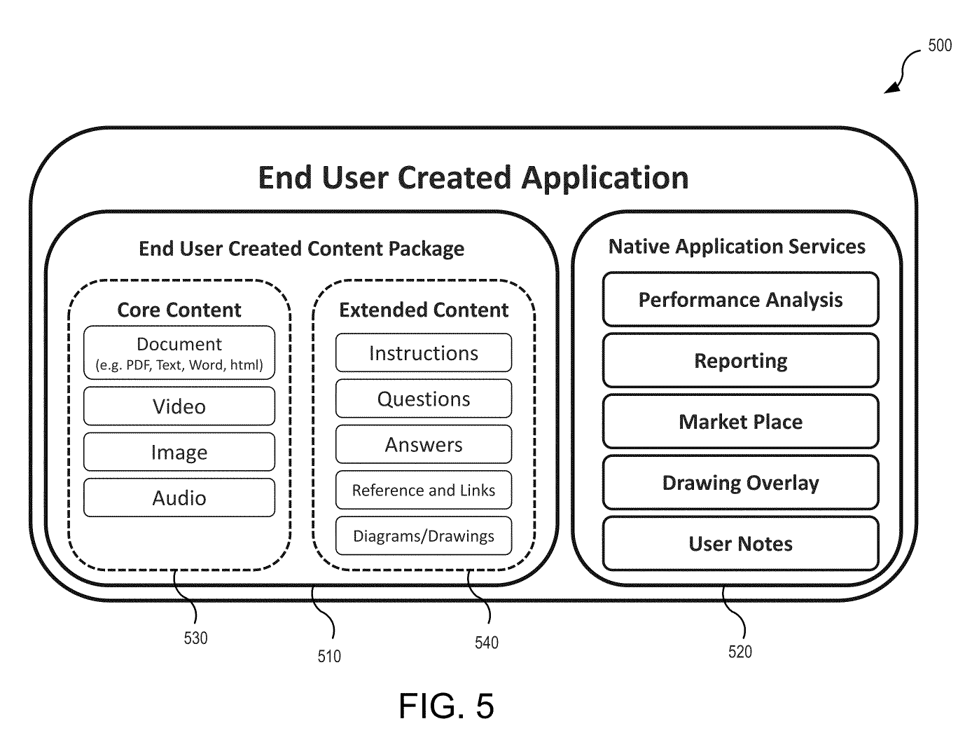

FIG. 5 is a block diagram of a customized application 500 with examples of the content and services which may be included in accordance with one or more embodiments of the present invention. Customized application 500 can include content package 510 created by the end user and application services 520. Content package 510 can include core content 530 which can be many pages or individual content elements. For example, core content 530 could include documents, videos, images, or audio files. In addition to core content 530, core content package 530 can also include extended content 540. Examples of extended content can include, but are not limited to, instructions questions, answers, references, links, diagrams, and drawings. Each page of content can have specified questions and answers, instructions, notes, timers, etc. For example, twenty pictures of different dog breeds with questions about each breed could be twenty pages in customized application 500.

In accordance with various embodiments, application services 520 are present within custom application 520. Examples of application services 520 include tools or modules for performance analysis, reporting, marketplace interaction, drawing overlays, and creating user notes. Other embodiments may include additional and/or different tools or applications. In some embodiments, the content creator can select which application services are included or activated for use by the consumer. In other cases, default application services may automatically be included as part of the final customized application.

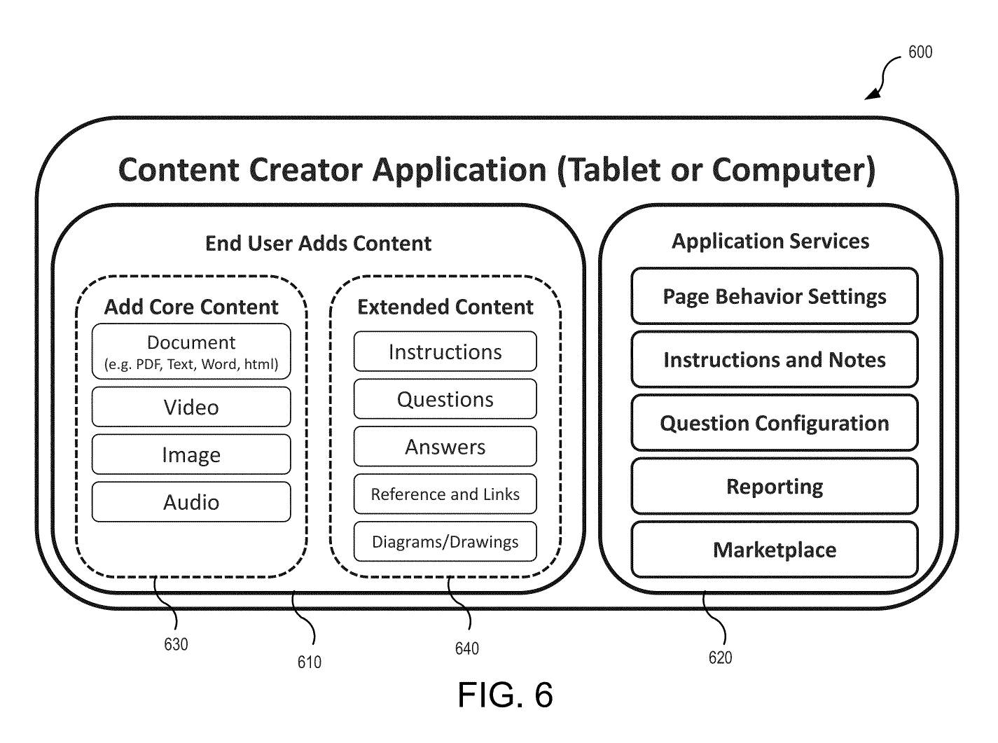

FIG. 6 is a block diagram of functional components of content creator application 600 which may be used in accordance with some embodiments of the present invention. Content creator application 600 can include a content creation package 610 and an application services selection package 620. Content creation package 610 allows the user to submit, create, or select core content 630 (e.g., documents, videos, images, or audio files) and extended content 630 (e.g., instructions questions, answers, references, links, diagrams, and drawings) to be added to the custom application. By using content creator application 600 the user can create the presentation flow of the content along with other types of behaviors (e.g., timers or specific requirements).

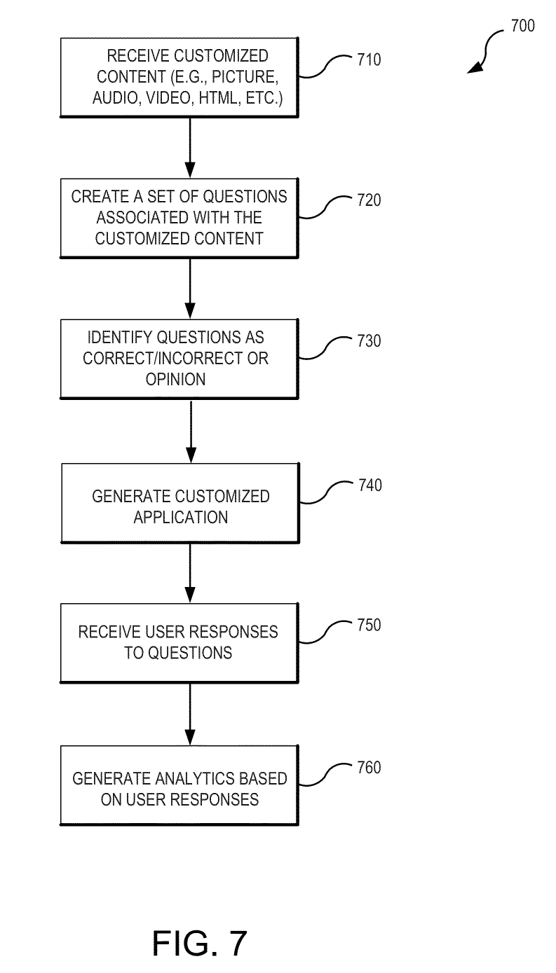

FIG. 7 is a flowchart with a set of operations 400 for generating analytics based on responses received through customized applications in accordance with some embodiments of the present invention. The operations illustrated in FIG. 7 may be implemented using one or more components and/or modules such as processor(s) 310, receiving module 315, question generator 325, application generator 330, response tracking module 325, and/or analytics engine 330. During receiving operation 710, a customized content element (e.g., a picture, audio file, video file, HTML file, etc.) may be received. The customized content element may be received directly from an end-user (e.g., through computing devices 110A-110N) or from a content database upon selection of the content from the user.

Once the customized content element has been received, question generation operation 720 allows a set of questions to be created and associated with the customized content element. Identification operation 730 may be used to identify the set of questions as having correct/incorrect answers or as opinion questions. This information may be used in processing the analytics and/or reports. Using the customized content element and the set of questions, application generation operation 740 generates a customized application which can be distributed to end-users.

During response gathering operation 750, user responses to the questions are received. These responses may be pushed or pulled from the computing devices that are being used to nm the customized applications. Analytics generation operation 760 generates a set of analytics using the responses gathered during response gathering operation 750. The analytics generated may be for an individual end-user or for a group of end-users to allow for measuring and benchmarking the performance and/or opinions of the end-users.

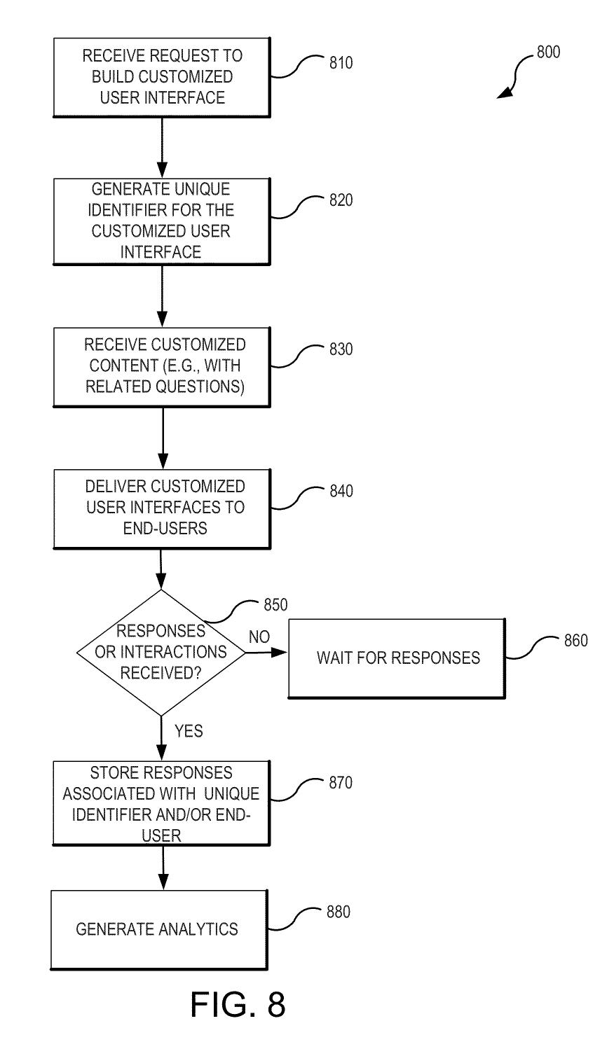

FIG. 8 is a flowchart with a set of operations 800 for measuring and benchmarking performance in accordance with various embodiments of the present invention. The operations illustrated in FIG. 8 may be implemented using one or more components and/or modules such as processor(s) 310 and/or content marketplace 120. During receiving operation 810 a request to build a customized user interface is received. A unique identifier is assigned to the customized user interface during identification operation 820. Customization operation 830 allows the user to customize the content (e.g., with questions and/or teaching material) within the user interface through a submission and/or selection process.

Once the customized content has been received, delivery operation 840 delivers the customized user interfaces to the end-users. Decision operation 850 determines if any responses or interactions with the customized content have been submitted by the end-users through the customized interfaces. If decision operation 850 determines that no responses have been received, then decision operation 850 continues to wait for responses during wait operation 860. If decision operation 850 determines that responses have been received, then decision operation 850 branches to storing operation 870 where the responses are associated with unique identifier(s) of the customized user interface and/or end-user. The responses are then stored for later use. Analysis operation 880 can then retrieve the responses (e.g., by end-user) and generate analytics which can be used to measure and benchmark performance.

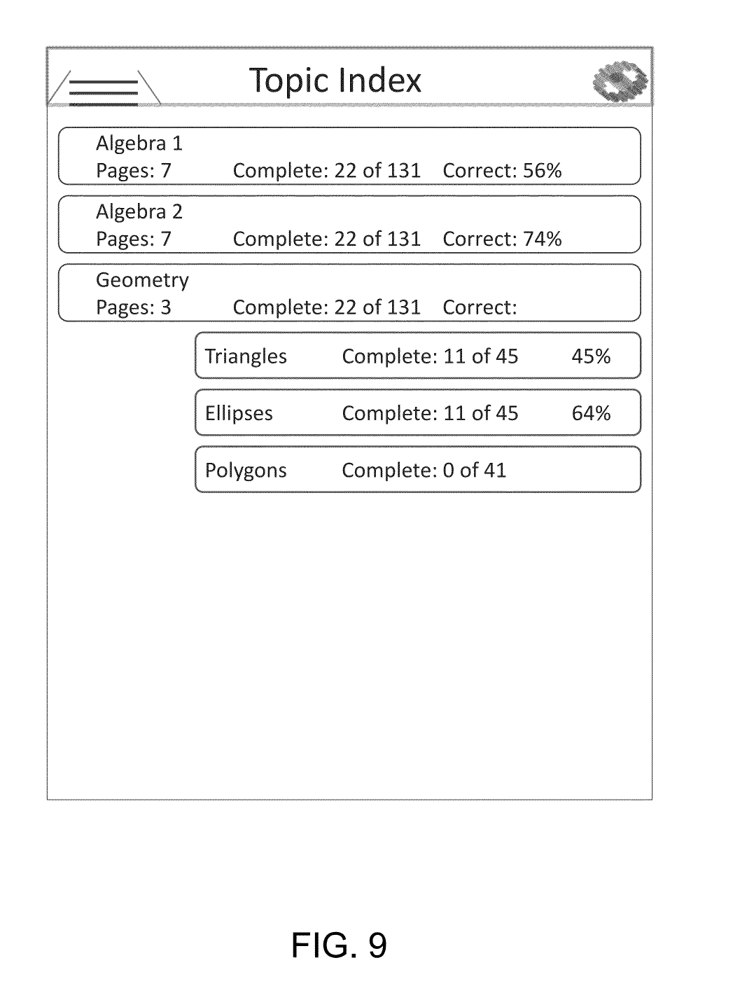

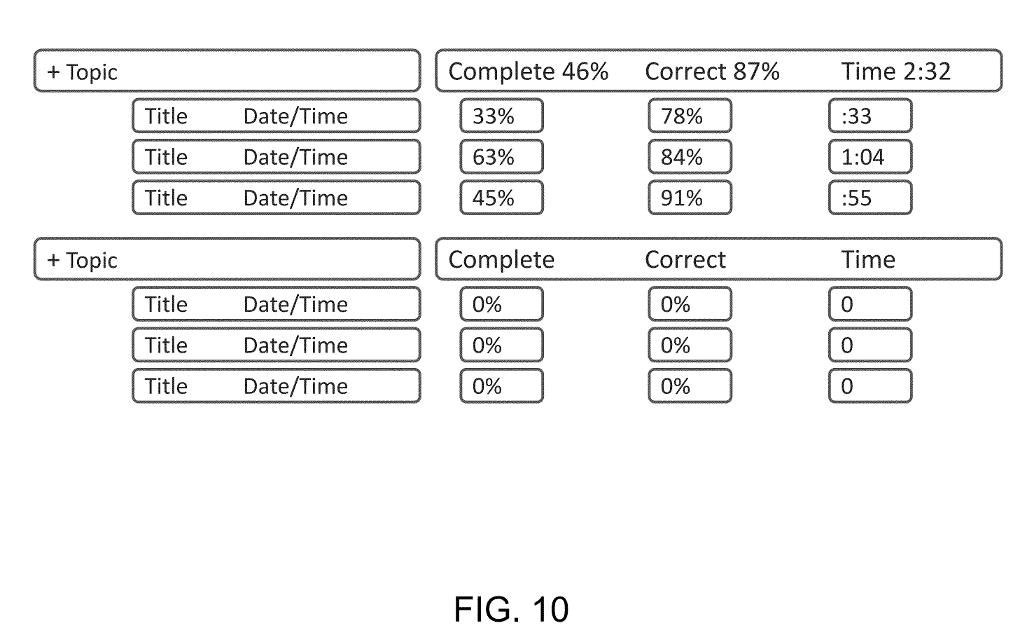

FIGS. 9 and 10 are examples of performance reports which may be generated in accordance with one or more embodiments of the present invention. As illustrated in FIG. 9, lists of topics contained within a content application can be included in a report. Along with each topic an indication of the number of questions completed with an overview of the performance to date can be included. In FIG. 9, expanding a topic shows the pages and subtopics under that topic. User performance is also shown for the project and the individual pages of the project. FIG. 10 shows an alternate report that includes the topics along with information regarding the amount of time spent, amount completed, percent correct.

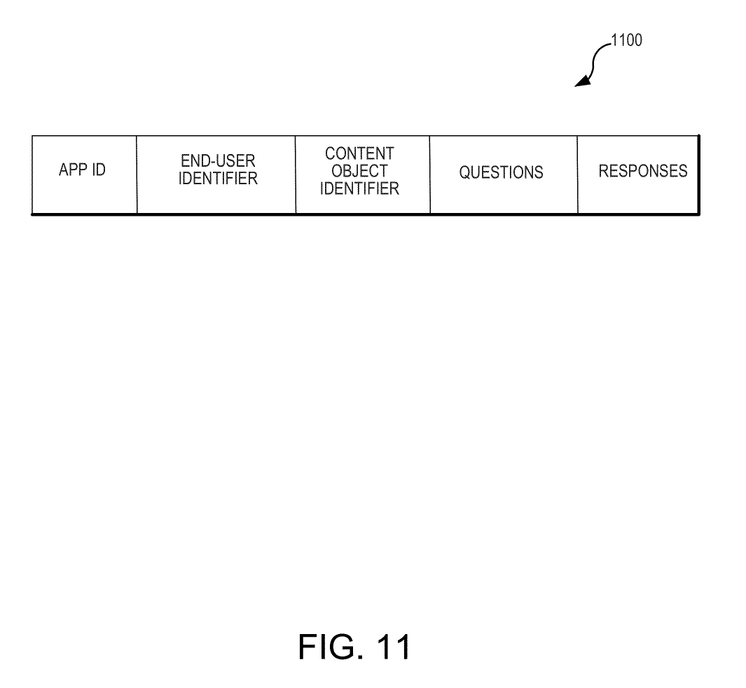

FIG. 11 illustrates a data structure 1100 which some embodiments of the present invention may utilize. As illustrated in the data structure shown in FIG. 11, an application identifier, an end-user identifier, content element identifiers, questions, and responses may all be stored data structure 1100. This information may be access by a customized application in order to download the customized content (i.e., content element and questions). In addition, data structure 1100 may be accessed by various components of the system to retrieve various information (e.g., for generating analytics). In other embodiments, data structure 1100 may include additional fields and/or information which may be useful. For example, in one embodiment, an expense field may also be used to track charges.

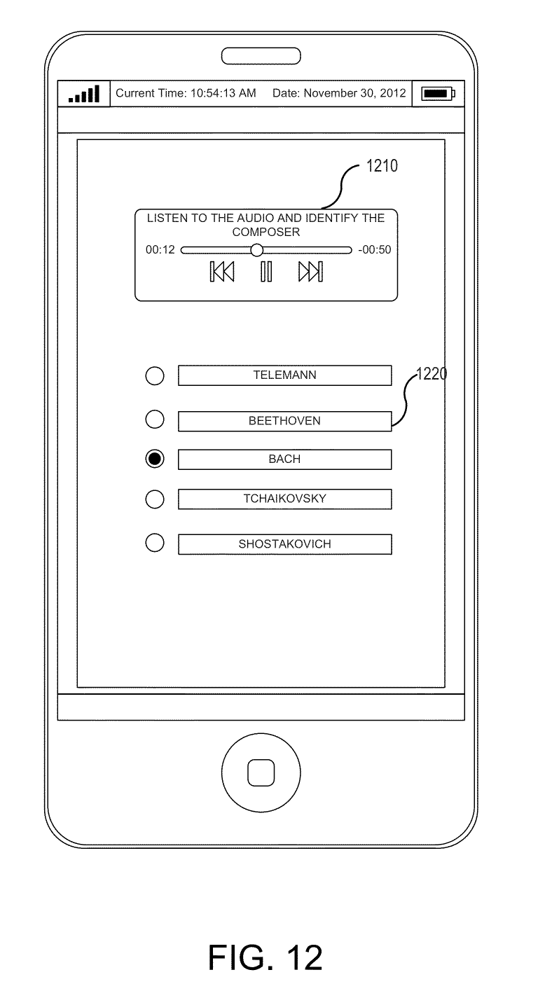

FIG. 12 illustrates an example of a customized application that may be created in accordance with one or more embodiments of the present invention. In the example presented in FIG. 12, the developer has downloaded an audio clip 1210 and asked the end-users to identifier the composer. In this case, the developer chose to present multiple choice answers 1220 from which the end-users can choose from. The answer selected by the end-user can be transferred back to content marketplace 120 or other data repository where the information can be stored and analyzed.

While FIG. 12 shows audio clip 1210 with a question having multiple choice answers 1220, other customized applications may include other types of content elements and additional content along with or instead of the audio file, question, and multiple choice answers. For example, in some cases, educational text may be included below the content element providing information or instructions to an end-user. In the example presented in FIG. 12, the additional information or instructions may identify common characteristics of various composers that may help the end-user to properly identify the composer. Additionally, links to on-line stores or websites may be included that allow the end-user to easily find more information and/or purchase materials. Still yet, other types of additional content which may have educational, marketing, and/or other purposes may be included with the content element.

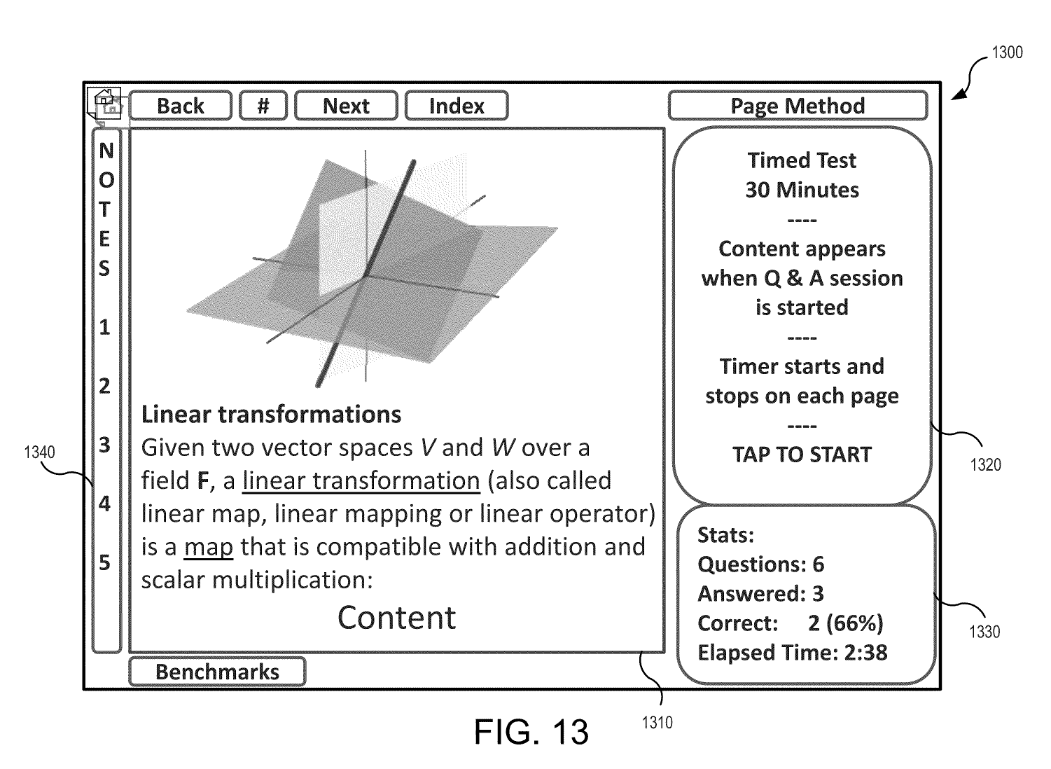

FIG. 13 illustrates an example of another customized application 1300 that may be created in accordance with one or more embodiments of the present invention. As illustrated in FIG. 13, customized application 1300 includes a content section 1310 and a testing section 1320. Testing section 1320 presents the questions and answers for a timed test upon selection by the user. Performance statistics are recorded and summarized for the user in performance section 1330. These sections may be expandable and collapsible as illustrated with notes section 1340.

The question and answer entry interface can be designed to be smooth, fast, and easy to operate in order to not be a hindrance in a timed testing mode. Depending on the type of answers need, different entry interfaces may be used. Examples include, but are not limited to multiple choice, numeric keypads, mathematical equation editors, calculator keypads, native keyboards, and others. Each project, page, or question can have one or more behavior settings allowing, limiting, or restriction functionality. For example, during a test the behavior setting may disable most of the buttons so that users do not accidentally exit the test or access personal notes.

### Exemplary Computer System Overview

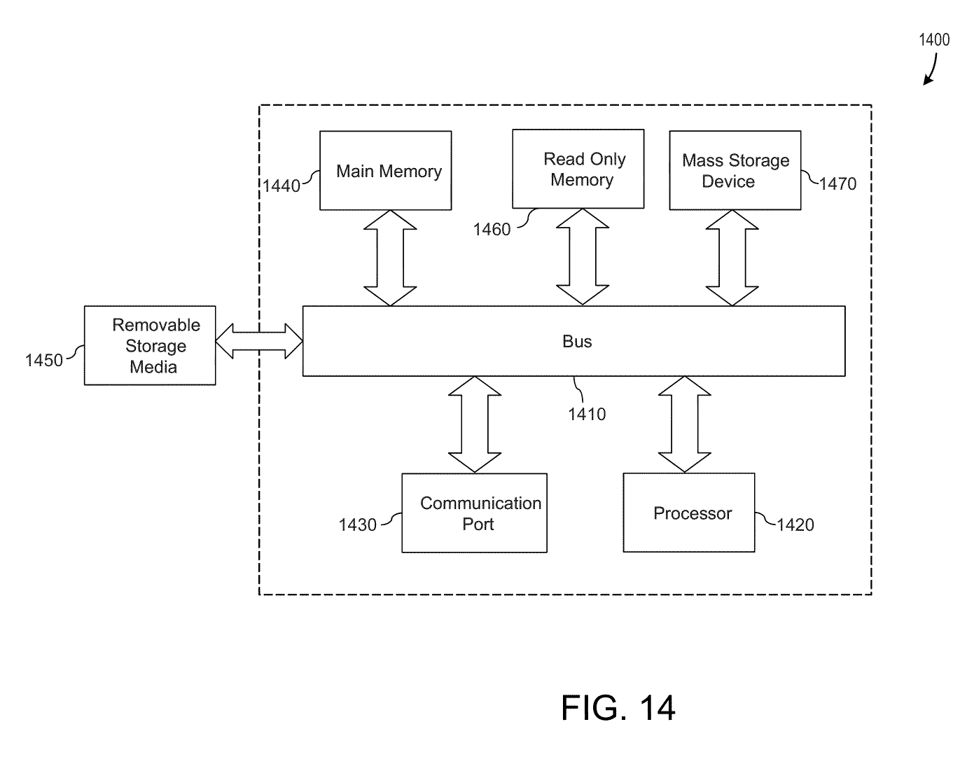

Embodiments of the present invention include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 14 is an example of a computer system 1400 with which embodiments of the present invention may be utilized. According to the present example, the computer system includes a bus 1410, at least one processor 1420, at least one communication port 1430, a main memory 1440, a removable storage media 1450, a read only memory 1460, and a mass storage 1470.

Processor(s) 1420 can be any known processor, such as, but not limited to, an Intel® Itanium® or Itanium 2® processor(s); AMD® Opteron® or Athlon MP® processor(s); or Motorola® lines of processors. Communication port(s) 1430 can be any of an RS-232 port for use with a modem-based dialup connection, a 10/100 Ethernet port, or a Gigabit port using copper or fiber. Communication port(s) 1430 may be chosen depending on a network such as a Local Area Network (LAN), Wide Area Network (WAN), or any network to which the computer system 1400 connects.

Main memory 1440 can be Random Access Memory (RAM) or any other dynamic storage device(s) commonly known in the art. Read only memory 1460 can be any static storage device(s) such as Programmable Read Only Memory (PROM) chips for storing static information such as instructions for processor 1420.

Mass storage 1470 can be used to store information and instructions. For example, hard disks such as the Adaptec® family of SCSI drives, an optical disc, an array of disks such as RAID, such as the Adaptec family of RAID drives, or any other mass storage devices may be used.

Bus 1410 communicatively couples processor(s) 1420 with the other memory, storage and communication blocks. Bus 1410 can be a PCI/PCI-X or SCSI based system bus depending on the storage devices used.

Removable storage media 1450 can be any kind of external hard-drives, floppy drives, IOMEGA® Zip Drives, Compact Disc-Read Only Memory (CD-ROM), Compact Disc-Re-Writable (CD-RW), and/or Digital Video Disk-Read Only Memory (DVD-ROM).

The components described above are meant to exemplify some types of possibilities. In no way should the aforementioned examples limit the scope of the invention, as they are only exemplary embodiments.

In conclusion, the present invention provides novel systems, methods and arrangements for creating customized applications. While detailed descriptions of one or more embodiments of the invention have been given above, various alternatives, modifications, and equivalents will be apparent to those skilled in the art without varying from the spirit of the invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations that fall within the scope of the claims, together with all equivalents thereof. Therefore, the above description should not be taken as limiting the scope of the invention, which is defined by the appended claims.

What is claimed is:

1. A method comprising:
receiving, through a content portal, a content element;
developing additional content around the content element, wherein the additional content includes a question associated with multiple choice answers;
creating a customized application that shows the content element, the additional content, and can receive user interactions and responses including a selection of one of the multiple choice answers;
distributing the customized application to a set of end-users; and
tracking the user interactions and responses for the set of end-users.

2. The method of claim 1, wherein the content element includes a video file, an audio file, a document, executable software, or a picture.

3. The method of claim 1, further comprising identifying the question as correct/incorrect or as opinion.

4. The method of claim 1, wherein developing the additional content includes searching a knowledge database for information regarding the content element and automatically presenting a proposed set of questions from which a content developer can select.

5. The method of claim 4, wherein the question is a first question of a plurality of questions regarding the content element.

6. The method of claim 1, further comprising searching a content store for the content element and additional content.

7. The method of claim 1, further comprising associating the content element and the additional content a unique identifier which can be retrieved when one of the end-users from the set of end-users accesses the customized application.

8. A system comprising:
a client running on an end-terminal, the client configured to receive a content element, a question regarding the content element, and a set of answers associated with the question;
an application generation platform configured to receive, through a network, the content element, the question regarding the content element, and the set of answers associated with the question, the application generation platform configured to generate a customized application based on the content element, the question, and the set of answers;
a distribution platform to distribute the customized application to a group of end-users; and
an analysis platform configured to receive user responses entered into the customized application for each end-user in the group of end-users and generate analytics to measure and benchmark performance of the group of end-users and each end-user individually.

9. The system of claim 8, further comprising a database having stored thereon a plurality of content elements searchable by one or more keywords.

10. The system of claim 8, wherein the analysis platform includes a response tracking module to track the responses to the question from the group of end-users.

11. The system of claim 8, further comprising a knowledge evaluation module to evaluate responses generated by each end-user and to identify deficiencies in a knowledge base of each end-user around the content element.

12. The system of claim 9, further comprising a lesson plan module configured to receive the deficiencies identified from the knowledge evaluation module and generate a lesson plan based on the deficiencies.

13. The system of claim 8, further comprising a reporting module configured to generate a report regarding each end-user and the group of end-users based on responses to the question received through the customized application.

14. The system of claim 8, wherein the distribution platform distributes the customized application to one or more mobile devices.

15. The system of claim 8, wherein the client presents one or more templates for presenting the content element, the question, and the set of answers within the customized application.

16. A computer-implemented method comprising:
displaying a first user interface screen on a computing device, the first user interface screen including a content element selection screen configured to receive one or more content elements from either a manual input or a selection based on keywords provided by the user;
displaying a second user interface screen on the computing device in response to receiving the one or more content elements, wherein the second user interface screen allows for entry or selection of one or more questions regarding the one or more content elements; and
creating a customized application that shows the one or more content elements, the one or more questions, and is configured to receive user responses to the one or more questions.

17. The computer-implemented method of claim 16, further comprising storing the one or more content elements and the one or more questions in a data structure.

18. The computer-implemented method of claim 17, wherein creating the customized application includes accessing the data structure to retrieve the one or more content elements and the one or more questions.

19. The computer-implemented method of claim 16, further comprising distributing the customized application to a set of end-users and tracking the user responses from the set of end-users.

20. The computer-implemented method of claim 19, further comprising generating analytics based on the user responses from the set of end-users.

21. The computer-implemented method of claim 20, further comprising generating a customized lesson plan based on the analytics.

22. The computer-implemented method of claim 16, wherein the one or more content elements include images, documents, video, audio, HyperText Markup Language (HTML), or executable code.

23. A system comprising:
a receiving means for receiving a content element and educational content regarding the content element;
a generating means for generating a customized application based on the content element and the educational content;
a distribution means for distributing the customized application to a group of end-users; and
an analysis means for receiving data regarding interactions of the group of end users with the customized application and for generating analytics regarding the interactions of the group of end-users.

24. The system of claim 23, further comprising a database having stored thereon a plurality of content elements associated with a set of educational content indexed to allow for searches based on one or more keywords.

25. The system of claim 23, wherein the educational content includes one or more questions, interactive games, reading material, or links to websites about the content element to measure the understanding of each end-user.

26. The system of claim 23, wherein the educational content includes one or more multiple choice questions about the content element to measure the understanding of each end-user.

27. The system of claim 23, further comprising an identification means to evaluate interactions with the educational content and identify deficiencies in a knowledge base of each end-user around the content element.

28. The system of claim 27, further comprising a means for planning a series of customized applications with different content elements or educational content to remedy the deficiencies in the knowledge base of each end-user.

29. The system of claim 23, wherein the interactions include time spent using the customized application, answers to questions presented within the customized application, or questions submitted by one of the end-users to a moderator or to the group of end users.
